(19) United States
(12) Patent Application Publication
(10) Pub. No.: US 2008/0174248 A1
(43) Pub. Date: Jul. 24, 2008

(54) Lighting module power-saving control method

(75) Inventor: Chao-Chin Yeh, Changhwa County (TW)

Correspondence Address: BROWDY AND NEIMARK, P.L.L.C.;624 NINTH STREET, NW, SUITE 300, WASHINGTON, DC, 20001-5303, US

(73) Assignee: Chuan Shih Industrial Co., Ltd., Tien Chung Township (TW)

(21) Appl. No.: 11/730,500

(22) Filed: Apr. 2, 2007

(30) Foreign Application Priority Data
Jan. 22, 2007 (TW) 96102381

(51) Int. Cl. H05B 39/00

(52) U.S. Cl. 315/160

(57) ABSTRACT

A lighting module power-saving control method in which a switching control loop is installed in a lamp for outputting a high-frequency current output signal and a low-frequency current output signal, the length of a unit time is divided into multiple equal parts for enabling the power output loop of the lamp to alternatively output a normal-consumption current and a power-saving current to the lighting module of the lamp subject to the control of the switching control loop, and the frequency of the supply of the normal-consumption current is not less than 16 times/second.

### BACKGROUND OF THE INVENTION

1. Field of the Invention

The present invention relates to lighting module control means and more particularly, to a light module power-saving control method.

2. Description of the Related Art

According to the light emitting mode of conventional light emitting devices including halogen lamp, incandescent lamp, fluorescent lamp, cold cathode fluorescent lamp, HID (High-Intensity Discharge) lamp, LED (Light Emitting Diode), a same power is consumed during lighting. For example, if a light emitting device is turned on with a watt consumption “w” and the length of turn-on period is “t”, the light emitting device keeps consuming power supply at the watt consumption “w” within the whole length of turn-on period “t”. If the length of the time period is divided into 1000 equal parts, the power consumption time of watt consumption “w” of the light emitting device is 1000/1000, as shown in FIG. 1. Under certain conditions, this power consumption manner is a waste. If the light emitting device is not used for a special processing work but for illumination, it is not necessary to keep consuming power supply at the watt consumption “w” within the whole length of turn-on period “t” because of the persistence of human vision.

### SUMMARY OF THE INVENTION

The present invention has been accomplished under the circumstances in view. It is the main object of the present invention to provide a method of saving the power consumption of the lighting module of a lamp by means of the persistence of human vision.

To achieve this object of the present invention, the power-saving control method is used in a light emitting device having a power output loop and a lighting module to save power consumption. The method comprises the step of installing a switching control loop in the light emitting device for outputting a high-frequency current output signal and a low-frequency current output signal at each time share cycle, and the step of diving the length of a unit time into multiple equal parts for enabling the power output loop to alternatively output a normal-consumption current and a power-saving current to the lighting module subject to the control of the switching control loop, wherein the frequency of the supply of the normal-consumption current is not less than 16 times/second.

### BRIEF DESCRIPTION OF THE DRAWINGS

FIG. 1 is a schematic drawing showing the relationship between power consumption and time during operation of a light emitting device according to the prior art.

FIG. 2 is a circuit diagram of a lamp in accordance with a first embodiment of the present invention.

FIG. 3 is a schematic drawing showing the relationship between power consumption and time during operation of a lamp according to the first embodiment of the present invention.

FIG. 4 is a schematic drawing showing the relationship between power consumption and time during operation of a lamp according to a second embodiment of the present invention.

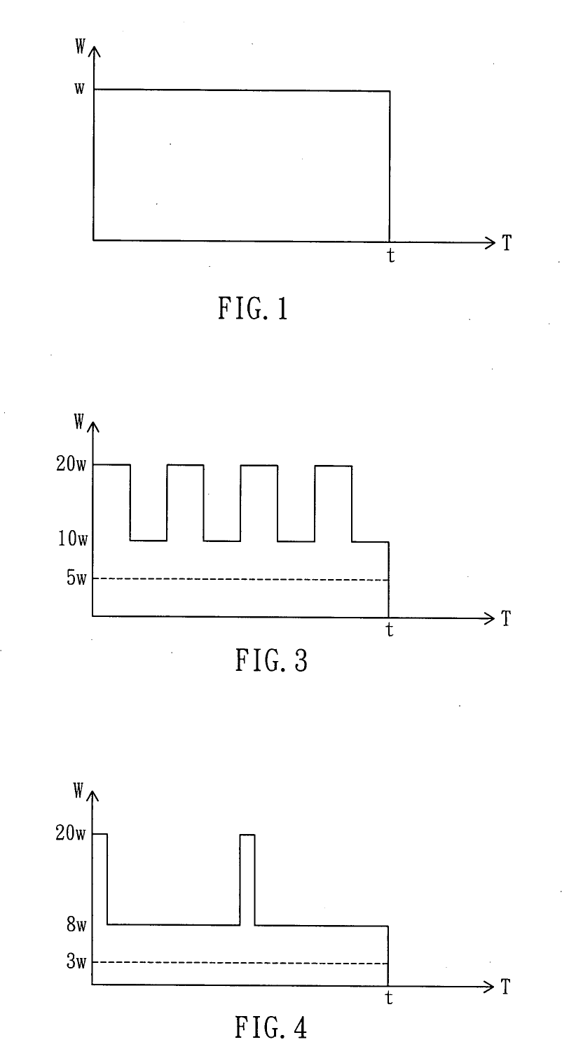

### DETAILED DESCRIPTION OF THE INVENTION

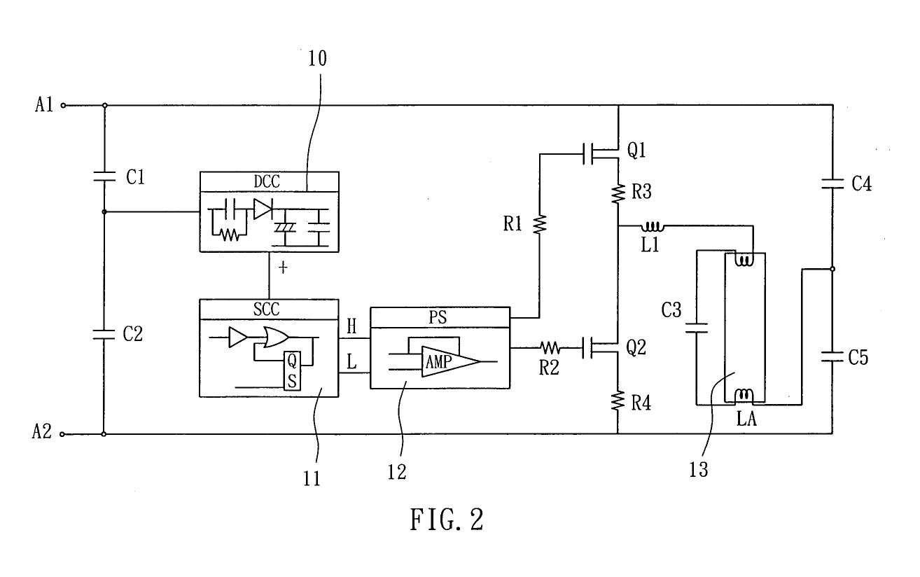

FIG. 2 is a circuit diagram of a lamp in accordance with a first embodiment of the present invention. As illustrated, the lamp comprises a DC power loop 10, a switching control loop 11 connected to the DC power loop 10, a power output loop 12 connected to the switching control loop 11, and a lighting module 13 connected to the power output loop 12. According to this embodiment, the lamp is a compact fluorescent lamp.

The switching control loop 11 provides a high-frequency current output signal and a low-frequency current output signal at a milli-second time division cycle. It divides the length of a unit time “t” into multiple equal parts in which signals are respectively outputted. The power output loop 12 executes output of different currents subject to the control of the switching control loop 11, i.e., the power output loop 12 is controlled by the switching control loop 11 to output a normal-consumption current to the lighting module 13 within a predetermined length of time, and to output a power-saving current to the lighting module 13 within another predetermined length of time. The frequency of the supply of the normal-consumption current to the lighting module 13 is higher than or equal to 16 times/second, and the power-saving current must be greater than or equal to the minimum exciting current of the lighting module 13.

In an example of a fluorescent lamp tube in which the minimum exiting current is 5 W, the normal-consumption current is 20 W, and the power-saving current is 10 W, the unit time is 1 second and divided into 1000 equal parts, and the normal-consumption current and the power-saving current are alternatively supplied by the power output loop 12 to the lighting module 13 at every 1/1000 second, as shown in FIG. 3, causing the lighting module 13 to emit light. Therefore, the power output loop 12 outputs the normal-consumption power to the lighting module 13 500 times in one second, the 20 W consuming time is ½ second, and the 10 W consuming time is ½ second, i.e., it saves about 25% of power consumption when compared with a conventional 20 W fluorescent lamp. Although the lighting module does not keep consuming the normal-consumption current 20 W all the time within this 1 second, the supply frequency of the normal-consumption current 20 W to the lighting module is higher than 16 times/second, the effect of the persistence of human vision makes people feel constant brightness of the lamp under the normal-consumption current. Therefore, saving of power consumption is achieved.

According to a second embodiment of the present invention, as shown in FIG. 4, the minimum exciting current is 3 W, the normal-consumption current is 20 W, and the power-saving current is 8 W. If the unit time is 1 second and divided into 1000 equal parts and if the normal-consumption current and the power-saving current are alternatively supplied by the power output loop to the lighting module for 1/1000 second and 9/1000 second respectively, the power output loop outputs the normal-consumption power to the lighting module 100 times in one second, the 20 W consuming time is 1/10 second, and the 8 W consuming time is 9/10 second, i.e., it saves about 54% of power consumption when compared with a conventional 20 W fluorescent lamp. Although the lighting module does not keep consuming the normal-consumption current 20 W all the time within this 1 second, the supply frequency of the normal-consumption current 20 W to the lighting module is higher than 16 times/second, the effect of the persistence of human vision makes people feel constant brightness of the lamp under the normal-consumption current. Therefore, saving of power consumption is achieved.

In addition to fluorescent lamp, the invention is also applicable to cold cathode fluorescent lamp, HID (High-Intensity Discharge) lamp, as well as LED (Light Emitting Diode).

Although particular embodiments of the invention have been described in detail for purposes of illustration, various modifications and enhancements may be

What is claimed is:

1. A lighting module power-saving control method used in a light emitting device having a power output loop and a lighting module to save power consumption, the method comprising a step of installing a switching control loop in said light emitting device for outputting a high-frequency current output signal and a low-frequency current output signal at each time share cycle, a step of diving the length of a unit time into multiple equal parts for enabling said power output loop to alternatively output a normal-consumption current and a power-saving current to said lighting module subject to the control of said switching control loop, wherein the frequency of the supply of said normal-consumption current is not less than 16 times/second.

2. The lighting module power-saving control method as claimed in claim 1, wherein said switching control loop controls said power output loop to output said normal-consumption current and said power-saving current to said lighting module at a milli-second time division cycle.

3. The lighting module power-saving control method as claimed in claim 1, wherein said power-saving current is not less than the minimum exciting current of said lighting module 4. The lighting module power-saving control method as claimed in claim 1, wherein the total supplying time of said normal-consumption current in said unit time is longer than the total supplying time of said power-saving current in said unit time.
